(19) United States
(12) Patent Application Publication
(10) Pub. No.: US 2024/0125166 A1
(43) Pub. Date: Apr. 18, 2024

(54) DOOR SYSTEM FOR ONE OR MORE DOORS

(71) Applicants: DORMAKABA DEUTSCHLAND GMBH, Ennepetal (DE); DORMAKABA EAD GMBH, Villingen- Schwenningen (DE)

(72) Inventors: Stephan GIERNICH, Bonn (DE); Dennis MEIERING, Ennepetal (DE); Sven BUSCH, Ennepetal (DE)

(21) Appl. No.: 18/547,288

(22) PCT Filed: Feb. 23, 2022
(86) PCT No.: PCT/EP2022/054533

§ 371 Date: Aug. 21, 2023

(30) Foreign Application Priority Data
Feb. 24, 2021 (EP) 21159073.2
Aug. 19, 2021 (WO) PCT/EP2021/073068

(51) Int. Cl. E05F 15/73

(52) U.S. Cl. CPC E05F 15/73; E05Y 2400/415; E05Y 2400/44; E05Y 2400/458; E05Y 2400/52

(57) ABSTRACT

A door system for one or more doors, wherein the door system includes at least one motor door drive, and the door drive includes a motor and a drive controller for actuating the motor of the door drive. The door system includes a controller which is connected to the drive controller.

### CROSS-REFERENCE TO RELATED APPLICATIONS

This application is a 35 U.S.C. § 371 National Stage patent application of PCT/EP2022/054533, filed on 23 Feb. 2022, which claims the benefit of International Application No. PCT/EP2021/073068, filed on 19 Aug. 2021, which claims the benefit of European patent application 21159073.2, filed on 24 Feb. 2021, the disclosures of which are incorporated herein by reference in their entirety.

### TECHNICAL FIELD

The present disclosure relates to a door system for one or a plurality of doors. The door system according to the disclosure comprises at least one motorized door drive. The door drive comprises a motor and a drive controller for actuating the motor of the door drive.

### BACKGROUND

Motorized door drives are known from the prior art. The door drives have a drive controller. The drive controller is used to actuate the motor so that the motor moves a door leaf to open or close a door. For this purpose, the drive controller is connected to a signal transmitter, e.g. a manual switch or a sensor, on whose signal the drive controller actuates the motor. Furthermore, the drive controller can operate in different operating modes, e.g. an automatic mode or a manual mode. However, it is expensive to integrate door drives according to the prior art into complex functional processes or complex door opening decisions.

### SUMMARY

The present disclosure therefore provides a door system with a door drive, with which complex functional processes and/or complex decisions are made possible.

The disclosure provides a door system according to claim 1. Advantageous further developments of the door system are specified in the dependent claims, in the description and in the drawings. In this case, the features mentioned in the description and in the claims may each be essential to the disclosure individually by themselves or in combination.

According to the disclosure, it is provided that the door system comprises a control device which is connected to the drive controller.

Because the door system comprises an additional control device, the electronic intelligence of the door system is increased. This enables the door system to make more complex decisions. In particular, if the door system comprises additional door components, it is possible to replicate more complex functional processes by means of the control device.

The control device is designed in particular as an electronic control device. The control device preferably comprises an electronic processor. The control device preferably comprises at least one electronic memory.

The control device can preferably comprise a timer for measuring times or durations.

The drive controller is designed in particular as an electronic drive controller. The drive controller preferably comprises an electronic processor. The drive controller preferably comprises at least one electronic memory.

The drive controller and the control device are preferably connected to one another in terms of information technology. The connection is thus designed as a connection via which electronic messages can be exchanged with one another.

The drive controller and the control device can be electrically connected to one another.

The drive controller and the control device are preferably connected to a first bus system. This establishes the connection between the drive controller and the control device. A connection to a bus system is understood below as a direct connection such that a component connected to the bus system is to be regarded as a participant of the bus system with its own bus address.

The first bus system can in particular be a communication bus. The first bus system can be a wired bus. The first bus system can be a field bus, e.g. a CAN bus.

The door drive can be a sliding door drive, a swing leaf door drive or a revolving door drive.

The control device can preferably be connected in terms of information technology to a computing unit. The computing unit can be designed as a cloud, for example. The control device can use the information technology connection to send electronic messages to the computing unit and/or to receive them from the computing unit.

The control device can preferably be connected to a second bus system. The second bus system can in particular be a communication bus. The second bus system is preferably IP-enabled. For example, the second bus system can be designed as an Ethernet, LON or LAN bus.

It can be provided that the control device is designed to receive an electronic configuration via the information technology connection, in particular via the second bus system. The control device preferably receives the electronic configuration from the computing unit, in particular from a database of the computing unit.

The electronic configuration is used in particular to control the door system. In this case, the electronic configuration comprises information relating to the control device and/or the drive controller. The information for the door system is preferably combined in a common electronic configuration.

The electronic configuration is designed in particular as at least one electronic file. The electronic configuration is preferably designed as an electronic template. The electronic configuration can preferably comprise parameters for operating the door drive.

It can be provided that the control device is designed to send an operating status of the door system via the second bus system. The control device preferably sends the operating status to the computing unit. The operating status is stored electronically in particular in a database of the computing unit.

It may be that the control device comprises a transmitting and receiving unit for wireless near-field communication, e.g. Bluetooth Low Energy, WLAN or NFC. The control device e.g. a mobile terminal, e.g. a mobile telephone, a tablet or a laptop can communicate by means of the transmitting and receiving unit.

The drive controller is preferably not connected or connectable to the second bus system. Instead, the drive controller sends an electronic message to the control device, with the control device being designed to send the content of the electronic message via the second bus system, in particular to the computing unit.

In particular, the drive controller is designed to accelerate and/or brake the motor so that a door is opened, stopped and/or closed. The drive controller is preferably designed as a four-quadrant controller. The drive controller is thus designed to operate, in particular to accelerate, the motor in one direction of rotation and in the opposite direction of rotation. In addition, the drive controller can be designed to brake the motor in one direction of rotation and in the opposite direction of rotation. The motor of the door drive is preferably designed as a DC motor. It may be that it is a brushless DC motor. Thus, the drive controller can be designed to actuate the motor.

It can be provided that the control device comprises at least one processor and the drive controller at least one processor, with the control device comprising the higher computing power than the drive controller. It is thus provided in particular that complex decisions are made in the control device and/or complex functional processes are controlled by the control device.

The control device preferably comprises a hardware accelerator. The hardware accelerator is particularly preferably designed as an accelerator for using artificial intelligence. For example, the hardware accelerator can be designed as a vision processing unit (VPI).

In addition to the door drive and the control device, the door system preferably comprises further door components.

At least one of the further door components is used in particular to change the door state. The change of the door state can e.g. correspond to opening the door, closing the door, unlocking the door, locking the door, providing a state for manual unlocking and/or locking, opening and/or closing of the door.

The door system may comprise at least one door component that generates a signal for changing the door state. In particular, the signal can cause the motorized door drive to change the door state. The signal-generating door component is referred to below as a signal transmitter. The signal can be designed as a message, in particular a bus telegram.

It is preferably provided that the control device is designed to evaluate, based on received signals, whether the door is to be opened by means of the motor.

It can be provided that the control device is designed to evaluate, based on received signals, whether the door is to be closed by means of the motor.

It can be provided that the control device is designed to evaluate, based on received signals, whether the door is to be stopped by means of the motor.

In particular, the control device causes the drive controller to actuate the motor based on the evaluation. To this end, the control device of the drive controller preferably sends a message. For this purpose, the signal transmitter is preferably connected to the control device in terms of information technology. For example, the signal transmitter can be connected to the first bus system or a third bus system. The third bus system is preferably a field bus, in particular an RS485 bus. The control device receives the signal, preferably the electronic message, of the signal transmitter and evaluates the signal, preferably the message.

It can thus be provided that at least part of the evaluation of the signal, in particular the message that the door components emit, is evaluated by the control device.

It can be provided that the evaluation of the signal transmitter results in the control device instructing the drive controller to only use the motor to make a selection from the options of opening the door, closing the door or stopping the door. For example, the door component can be designed as a manual button, with the door being able to be opened when the manual button is actuated, but not closed or stopped.

For example, the door component that emits the signal, preferably the message, can be designed as a hazard alarm, in particular a smoke detector. The hazard alarm can be an individual sensor or can comprise a plurality of individual sensors that are connected to a hazard alarm center, with the hazard alarm center sending the signal, in particular the message, to the control device. The hazard alarm and/or the hazard alarm center is preferably connected to the first bus system.

The door system can comprise at least one sensor. A signal of the sensor is used to cause the door to open by means of the door drive. For example, the sensor can be used to detect a person or a person movement in a detection region, as a result of which a door can be opened. In an automatic mode of the door drive, the door is preferably opened when a person is located or is moving in the detection region. For example, the sensor can be designed as a movement sensor.

A signal of the sensor can be used to cause the door to close by means of the door drive.

A signal of the sensor can be used to cause the door to stop by means of the door drive. For example, the sensor can be used to detect a person in a detection region, as a result of which the door can be stopped. This is intended in particular if the person is in the travel path of the door leaf. For example, the sensor can be designed as a safety sensor.

The sensor, in particular the movement sensor, can be connected to the control device in terms of information technology. The sensor is preferably connected to the first bus system. The door system is preferably designed to evaluate the signals of the sensor by way of the control device, with the control device causing the drive controller to actuate the motor based on the evaluation. The signal transmitter can thus correspond to the sensor, in particular the movement sensor.

The door system can be designed to receive an access attribute of an authorized user. For this purpose, the door system can comprise a detection unit. The detection unit can be designed as a transmitting and receiving unit, as a biometric sensor, as a keypad for entering a PIN and/or as a contact element for making electrical contact with an in particular electronic key. The access attribute can be designed as a credential or a biometric feature of the user.

It may be that the door system comprises at least one reader. The reader preferably comprises a detection unit. The reader comprises e.g. a transmitting and receiving unit for wirelessly receiving an access attribute, in particular credentials. The transmitting and receiving unit can be designed to communicate with a mobile terminal, in particular a mobile telephone or a card, by near-field communication, in particular RFID, NFC or Bluetooth Low Energy. The access attribute, in particular the credential, can comprise an access code and/or at least one time window in which access is authorized.

It may be that the control device comprises a transmitting and receiving unit for wireless near-field communication, e.g. Bluetooth Low Energy or NFC. The control device can thus act as a reader at the same time.

The control device is preferably designed to make an access decision for an authorized user. For this purpose, the control device can receive the access attribute, in particular the credential, from the detection unit. For this purpose, the control device can receive the access attribute, in particular the credential, from the reader. Thus, the signal transmitter can be designed as a reader or as a detection unit. The control device can receive the access attribute, in particular the credential, via an information technology connection, in particular via the third bus system.

It may be that the control device causes the drive controller to actuate the motor, in particular to open the door, based on the access decision.

It is preferably provided that at least one parameter for actuating the motor is stored in the control device. It can be provided that at least one parameter for actuating the motor can be received by the control device. For example, the parameter can be received by the computing unit and/or the mobile terminal. The parameter can be included in the configuration.

It is preferably provided that the control device causes the drive controller to actuate the motor in accordance with the parameter.

The parameter can be used to set an opening speed of the door, which is actuated by the door drive. Additionally or alternatively, the parameter can be used to set a closing speed of the door, which is actuated by the door drive. Additionally or alternatively, the parameter can be used to set a hold-open time of the door which is actuated by the door drive. Additionally or alternatively, the parameter can be used to set the motor power of the door drive. Additionally or alternatively, the parameter can be used to set an opening width or an opening angle of the door which is actuated by the door drive. This allows the installation site or the users of the door to be taken into account.

Additionally or alternatively, the parameter can be used to determine whether the motor is to be actuated as a function of a user action, in particular as a function of a door handle being actuated by a user to open the door. This so-called Push&Go functionality first determines whether a user begins to open a door. Only in this case is the motor activated to open the door. It can preferably be stored in the control device whether the motor should only be activated to open the door when a user begins to open the door or whether the motor already opens when the sensor has detected the user.

It is preferably provided that at least one parameter for actuating the motor is stored individually for authorized users or for authorized user groups in the door system, in particular in the control device. In this way, different users or different user groups can be taken into account. The parameter can thus be designed differently for a first authorized user than for a second authorized user. For example, the opening angle is set to be larger for a wheelchair user than for a walking user. In another example, the hold-open time may be set to be longer for an old person than for a young person. The authorized users can thereby be divided into different user groups.

The control device preferably comprises a database. At least one parameter can be assigned to different users or different user groups in the database. The control device can recognize the user by the access attribute.

Additionally or alternatively, the parameter can be receivable by the door system, in particular by the control device, in particular as part of an access attribute. It is therefore not necessary to store the parameter in a database of the control device. Rather, the control device always receives the parameter when the authorized user requests access. In particular, the access attribute comprises the parameter. The access attribute is received via the detection unit, in particular via the transmitting and receiving unit. This means that the parameter is currently recorded again by the door system with each access. For example, the access attribute is captured by the reader.

Additionally or alternatively, at least one parameter for actuating the motor can be stored individually for access attributes or for access attribute groups in the door system, in particular in the control device. The control device preferably comprises a database in which at least one parameter is in each case assigned to different access attributes or different access attribute groups. For example, a nurse may carry multiple cards depending on whether the nurse is seeking access alone or with a hospital bed. Thus a plurality of access attributes can be assigned to the same user.

Additionally or alternatively, the parameter can depend on the use of the access attribute. The control device preferably comprises a database in which the parameter is linked to the use of the access attribute. The use can e.g. comprise a gesture in relation to the detection unit. For example, a card can be held in front of the reader for a long or short time. For example, the hold-open time is stored in the database as a parameter for holding the card for a longer duration than for a short hold.

It is preferably provided that the door system, in particular the control device, comprises a memory, with firmware being stored in the memory. The memory is in particular a non-volatile electronic memory. The firmware is used to carry out at least one process of a plurality of operating steps to be carried out by the door system. An operating step can correspond to the motorized opening, the motorized closing or the motorized stopping by means of the door drive.

The process comprises a plurality of operating steps. An operating step can e.g. be designed as a motorized door opening or a motorized door closure. In this case, the operating step is carried out by a motorized door drive, in particular a swing leaf door, sliding door drive and/or revolving door drive. The operating step can be designed to be a motorized door stopping, in particular to avoid a collision with a person.

The operating step can be designed, electrically triggered, to close the door by means of a door closer. The door closer can be integrated in the door drive.

For example, the operating step can be designed as an electrically performed door unlocking or an electrically performed door locking. In this case, the operating step is carried out in particular by a locking element, e.g. a motor lock, a drive lock or a door lock of an escape route security system, as a door component.

The operating step can e.g. be designed as electrically establishing a requirement for manual unlocking and/or locking. Here, the operating step is in particular carried out by an unlocking element, e.g. a door opener, an electromechanical lock cylinder or an electromechanical door fitting, as a door component.

The operating step can e.g. be designed as a visual and/or acoustic display of a state of the door system. For this purpose, a display device can be provided as a door component or as part of a door component, e.g. a reader, an emergency button, an escape route controller, a panic bar, a lock or a fitting. The state to be indicated visually and/or acoustically can be, for example, an unlocked state or a locked state of the door. The state to be indicated visually and/or acoustically can be, for example, that access authorization is present or denied. The state to be indicated visually and/or acoustically can be, for example, that an alarm state is present, for example due to the detection of smoke or due to the actuation of an emergency button. The state to be indicated visually and/or acoustically can be, for example, that an alarm state is present because the door has been in an open state for too long.

The firmware of the control device is preferably designed to carry out the process independently of the configuration of the motor of the door drive. This makes it possible to predefine a plurality of operating steps one after the other in the firmware of the control device. The control device can thus predefine the order in which the operating steps are to be carried out. The control device can actuate the further door components that are involved in the process, or send a message to the further door components, as a result of which the further door component carries out the next operating step. Thus, in the door system according to the disclosure, a distinction is preferably made between the process, i.e. when which door component has to carry out which operating step, and the motor-specific control by the drive controller. The motor-specific control, i.e. the energization of the motor to open, close or stop the door, is carried out by the drive controller, while the message, in particular the command, that in the process, in particular regardless of the configuration of the motor, the motor is actuated to open, to close and/or to stop, is carried out by the control device.

At least one other door component involved in the process, e.g. a locking element, in particular a motor lock, or an escape route controller, can comprise a control unit for carrying out an operating step or a plurality of operating steps. Preferably, the control device of the control unit at least partially predefines when in the process the operating step has to take place. To this end, the control device preferably sends a corresponding message to the control unit.

The control unit or the drive controller preferably also comprises firmware for carrying out operating steps, e.g. to actuate the motor, to actuate a door lock of the escape route security system or to electromechanically retract a bolt of the motor lock.

It can be provided that based on a message of the control device, the drive controller controls a plurality of operating steps in succession. For example, the drive controller can actuate a locking element, in particular a motor lock or a drive lock, to unlock the door and then the motor to open the door.

It can be provided that, based on a message of the control device, a control unit, for example the escape route controller, controls a plurality of operating steps in succession. For example, the escape route controller can actuate an electromagnetic or electromechanical door lock to unlock the door and then actuate a display device to display the state of the door lock.

The control device can send parameters, e.g. a hold-open time, to actuate the motor in the message or in the command.

Preferably the electronic configuration comprises the firmware or instructions for the firmware.

In the door system it can be predefined under which environmental conditions and in which way the motor is to be actuated. In the firmware, in particular the firmware of the control device, it can be predefined under which environmental conditions and in which way the motor is to be actuated. In particular, in a dangerous situation, it can be predefined whether the door is to be opened or closed by the motor.

For example, in the case of a smoke detector, the firmware can predefine whether the door is to be opened or closed. Furthermore, at least one condition can be stored in the firmware as to when the door is to be opened or closed in the case of a smoke detector.

The door system preferably comprises a control device and a plurality of door drives. The door drives each comprise a drive controller. Exactly one control device is preferably provided in each door system. In particular, the control device provides the information technology connection to the computing unit. In particular, the control device can control the process. In particular, the control device can decide on an access authorization. After the decision on the access authorization, the control device can preferably only actuate the door drive or only the door drives that are assigned to the door for which the access authorization has been issued.

The control device is preferably designed to coordinate the drive controllers for a process. The door drives are designed in particular to each be arranged on a door leaf of a double-leaf door and/or on door leaves of doors arranged one behind the other.

For example, the doors arranged one behind the other can form an interlock. At least one condition must therefore be met before a door is opened by means of a door drive. Preferably, one condition is that the other door is closed. At least one other or additional condition, such as e.g. the end of a decontamination, may be provided. In another example, the doors arranged one behind the other may be provided in a hospital ward or in the entrance region of a store.

The plurality of drive controllers and the control device are preferably connected in an information technology connection, in particular to the first bus system.

The drive controllers are preferably connected to the first bus system.

The process is stored in particular in the firmware.

The door system can comprise at least one locking element. The electrically actuatable locking element can cause the unlocking and/or locking of the door. The locking element can, for example, be designed as e.g. a motor lock, as a motorized lock cylinder, as a drive lock or an electromagnetic or electromechanical door lock. The motor lock can be a mortise lock. The door lock can be a door lock of an escape route security system. In the case of the drive lock, transmission of the motor to the door leaf can be blocked.

Alternatively, the locking element can be designed to transfer the door into a manually unlockable state. For example, the locking element can be designed as an electric door opener. The electric door opener can assume a state in which manual actuation of the door causes unlocking and simultaneously opening of the door, while in another state of the door opener, manual actuation of the door and thus unlocking and opening of the door is prevented. Other examples of providing a state for manually unlocking a door can be seen in an electromechanical lock cylinder and/or an electromechanical fitting.

The locking element can correspond to a door component. The locking element can be connected to the first bus system.

In particular, a process is predefined by the firmware, with the process comprising an operating step to be carried out by the motor and an operating step to be carried out by the locking element. By predefining the process in the firmware, a possibility is created to reproduce a complex process, such as e.g. for a disabled toilet, without additional electrical circuits.

In this case, it may be that the drive controller or the control device actuates the locking element.

It is preferably provided that the door system comprises a motor lock, with the drive controller actuating the motor lock, in particular with the motor lock being connected to the first bus system. This means that a door drive with a motorized lock can also be used on doors that do not have a control device.

It can be provided that the door system comprises an authentication device, with the authentication device being designed to receive an access attribute for authentication. The authentication device preferably decides on access.

The authentication device can comprise the detection unit or be connected to the detection unit in terms of information technology. For example, the control device acts as an authentication device, with the control device in particular being connected to at least one reader via a bus system, e.g. the third bus system.

The door system, in particular the control device, can be designed to switch an operating mode of the door drive, in particular from automatic mode to manual mode or vice versa, based on the access attribute and/or the type of use of the access attribute.

In the automatic mode, it can in particular be provided that, in the case of an approach of a person to the door detected by sensors, the door drive opens the door by motor. In the manual mode, the door drive refrains from opening the door by motor in the case of an approach of a person to the door detected by sensors.

Examples are the security guard leaving the building in the evening, or a business owner entering their shop in the morning. Based on the authentication, the operating mode of a plurality of door drives, preferably of a plurality of door drives of the door system, particularly preferably of all door drives of the door system is preferably switched over.

The door system, in particular the control device, can be designed to actuate a door drive to open a door leaf or to actuate a plurality of door drives to open a plurality of door leaves based on the access attribute and/or the type of use of the access attribute. Thus, based on the access attribute, a decision is made in particular by the control device as to whether one leaf or a plurality of leaves are opened by motor. For example, for a wheelchair user or a nurse with a hospital bed, both door leaves of a double-leaf door are opened by motor by the door drives of the door system, while only the active leaf of the double-leaf door is opened for individuals.

The door system, in particular the control device, can be designed, based on the access attribute and/or the type of use of the access attribute, to adhere to or to override a timed process for actuating a motor of a second door drive after actuating a motor of a first door drive according to a condition stored in the door system. Thus it can enable e.g. a fireman to open both interlock doors, while one of the interlock doors is always closed in normal operation.

A different use of an access attribute can be understood to be e.g. a different use of the detection unit. For example, in one case a card is held briefly in front of the reader and in another case for a long time in front of the reader. In another case, a key is turned briefly in one case and a key is kept turned for a long time in another.

For example, the control device comprises a database. At least one behavior can be assigned to different access attributes or different access attribute groups in the database.

Additionally or alternatively, the desired behavior can be receivable from the door system, in particular from the control device, in particular as part of an access attribute. It is therefore not necessary to store the desired behavior in a database of the control device. Rather, the control device always receives the desired behavior when the authorized user requests access. In particular, the access attribute comprises the desired behavior. The access attribute is received via the detection unit, in particular via the transmitting and receiving unit.

It can be provided that it is stored in the firmware which door components of the door system, which are connected to the first bus system, are necessary for the process.

The door system, in particular the control device, checks whether the door components are connected to the control device in terms of information technology. In particular, the control device checks whether the door components are connected to the first bus system or to the third bus system.

It can be provided that the control device refuses to carry out the process if the result of the test is negative. This provides protection against erroneous processes and/or manipulation.

Additionally or alternatively, the door system can submit at least one solution proposal to a maintenance person. For this purpose, a database can be provided in the control device or in the computing unit.

It may be that the door system, in particular the control device, has knowledge of door components installed in the door system and is designed to determine changes of the installed door components, with the door system changing to an electronically defined state when a change is determined, in particular generating an alarm. In particular, when there is a change, the door system automatically changes to the defined state. This provides protection against manipulation.

The communication preferably takes place in encrypted form via the information technology connection, in particular via the first, second and/or third bus system.

The drive controller and the control device can be arranged in a housing, with the housing in particular accommodating a motor of the door drive. The control device and the drive controller are thus preferably connected to one another via the first bus system. Nevertheless, the mechanical installation of an additional housing can be omitted.

When commissioning on site, a bus address of a door component is preferably linked to a role of the door component in the door system. The link is preferably stored in the control device. A role is understood to be a door component type, e.g. a drive controller, a motor lock, a sensor or the like. If there are a plurality of door components of the same door component type in the door system, the role also comprises a position, e.g. drive controller of the active leaf, motor lock of the passive leaf, reader of the first door or sensor on the second door. Because the control device knows which bus address is linked to which role, processes can be carried out via the first and/or third bus system, in particular by means of firmware. If a door component type is present only once in the door system, the door component can report its door component type to the control device, which links the door component type and thus the role to the bus address of the door component. If a door component type is present multiple times in the door system or if a particularly secure installation is to be carried out for the door components, the mobile terminal in particular has knowledge of an identifier of the door component, e.g. the bus address. An installer performing the commissioning process can assign a position to the identifier. For this purpose, the installer can find out which identifier belongs to which door component, e.g. by an acoustic or visual sign.

A door arrangement with a computing unit and/or a mobile terminal is also placed under protection.

### BRIEF DESCRIPTION OF THE DRAWINGS

Further details and advantages of the disclosure will be explained below on the basis of the exemplary embodiments shown in the figures. Technical features with identical functions are hereby provided with identical reference numerals in the figures. They show:

FIG. 1 a first exemplary embodiment of a door system according to the disclosure and a door arrangement according to the disclosure,

FIG. 2 a second exemplary embodiment of a door system according to the disclosure and a door arrangement according to the disclosure, and

FIG. 3 a third exemplary embodiment of a door system according to the disclosure and a door arrangement according to the disclosure.

### DETAILED DESCRIPTION OF THE DRAWINGS

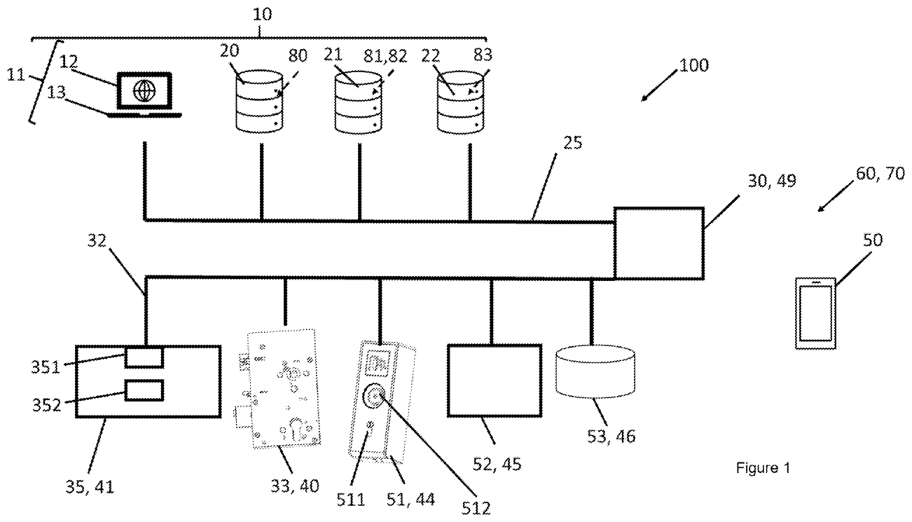

A first exemplary embodiment, a second exemplary embodiment and a third exemplary embodiment of a door system 60 according to the disclosure and a door arrangement 100 according to the disclosure are represented in FIGS. 1 to 3. The door arrangement 100 according to the disclosure comprises a computing unit 10. The computing unit 10 comprises a computing device 11 which is designed as a personal computer. The computing device comprises a screen 12 and a keyboard 13.

The computing unit 10 comprises at least one electronic memory. For example, this can be a memory in a cloud. A first database 20, a second database 21 and a third database 22 are stored in the memory. Alternatively and not represented, the first and the second database 20, 21 can be designed as a common database. The second and the third database 21, 22 can also be designed as a common database. In a further alternative, the first and the third database 20, 22 can be designed as a common database. In a further database, the first to third database 20, 21, 22 are integrated in a common database.

Different door systems 60, 61, 62 according to the disclosure are represented in FIGS. 1 to 3. The door systems 60, 61, 62 are each part of the door arrangement 100 according to the disclosure. According to the disclosure, the door systems 60, 61, 62 each comprise a control device 30 as a first door component. The door systems 60, 61, 62 each comprise a first bus system 32, e.g. a CAN bus. Furthermore, according to the disclosure, the door systems 60, 61, 62 each comprise at least one door drive 35, 36, for example a sliding door or swing leaf door drive. The door drive 35, 36 and the control device 30 are connected to the first bus system 32. Due to the fact that the control device 30 is present, it is possible to make complex functional processes and/or complex decisions.

The door drives 35, 36 each comprise a drive controller 351, 361 represented schematically, and a motor 352, 362 represented schematically. The drive controller 351, 361 is connected to the first bus system 32. The drive controller 351, 361 is used to actuate the motor 352, 362 of the respective door drive 35, 36 with a four-quadrant controller. For this purpose, the drive controller 351, 361 comprises at least one processor and at least one electronic memory.

The control device 30 also comprises at least one processor and at least one electronic memory. The processor of the control device 30 has a higher computing power than the drive controller 351, 361 and is also used to control processes of the door system 60, 61, 62. At least the control device 30 comprises a timer.

Furthermore, the control device 30 is used to establish the information technology connection to the computing unit 10. For this purpose, the control device 30 and the computing unit are connected to a second bus system 25, e.g. the Ethernet. The control device can receive an electronic configuration via the second bus system 25. The control device 30 can send operating data to computing unit 10. The operating data is stored in the third database 22.

The control device 30 and the drive controller 351 of the door system 60 or one of the drive controllers 351, 361 of the door systems 61, 62 are preferably arranged in a housing. The motor 352, 362 is also particularly preferably arranged in the housing.

The door systems 60, 61, 62 comprise further door components. The first door system 60 in FIG. 1 comprises, for example, a motor lock 33, an escape route controller 51 with an emergency button 512, an electromagnetic door lock 52 and a hazard detector, in particular a smoke detector 53, as further door components. The door components 35, 33, 51, 52, 53 have different functions and functional properties. Thus, the door components 33, 51, 52, 53 belong to different door component types 40, 44, 45, 46, just as the control device 30 and the motorized drive 35 each belong to different door component types 49, 41.

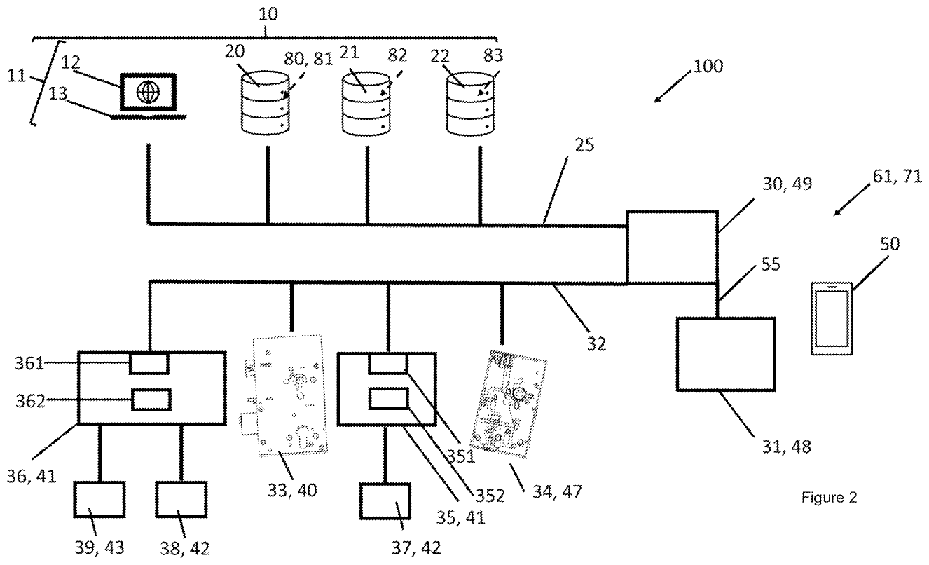

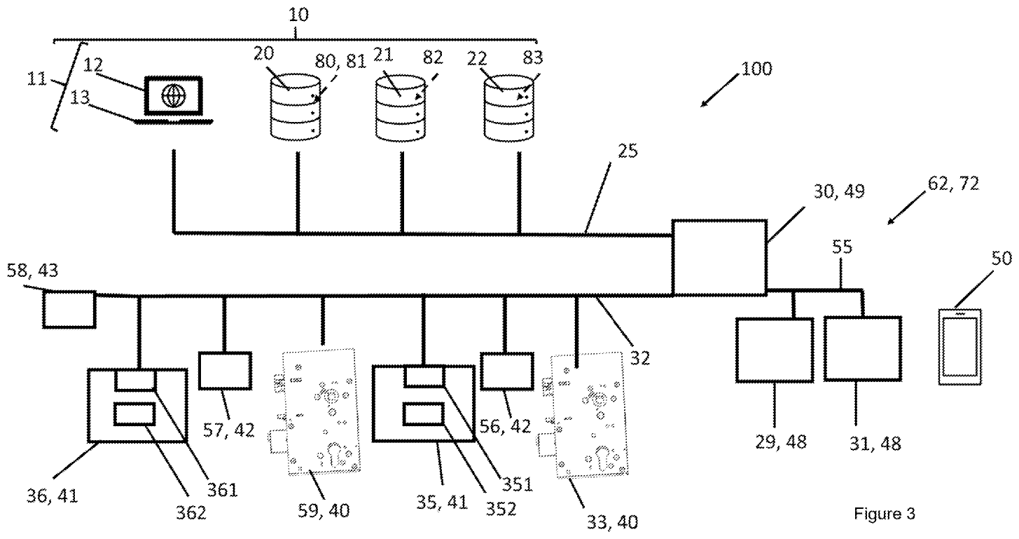

The second door system 61 in FIG. 2 and the third door system 62 in FIG. 3 each comprise a plurality of motorized door drives 35, 36 as door components. The motorized door drives 35, 36 are of identical design and thus belong to the same door component type 41. Furthermore, the second door system 61 and the third door system 62 comprise a plurality of sensors 37, 38 and 56, 57 as door components. The sensors 37, 38 and 56, 57 are used to detect a person approaching the door leaves. The motorized door drives 35, 36 can then open the door leaves in a sequence that is predefined in time as a functional process. In addition, safety sensors (not represented) can be used to stop the door by means of the door drive 35, 36 in order to avoid injuring the person. The sensors 37, 38 and 56, 57 are of identical design and therefore belong to the same door component types 42.

Furthermore, a program switch 39 or 58 is provided as a door component. A user can use the program switch 39, 58 to determine whether or not the sensors 37, 38 or 56, 57 cause a motorized door opening when a person is detected. Various operating modes, namely at least an automatic mode and a manual mode, can thus be set with the program switch. The program switch 39 is assigned to a separate door component type 43.

The door drives 35, 36 of the second door system 61 are designed to each be arranged on a door leaf of a double-leaf door. The second door system 61 comprises a motor lock 33 for an active leaf of the double-leaf door and a motor lock 34 for a passive leaf of the double-leaf door. The motorized locks 33, 34 are each assigned to their own door component types 40, 47. A further door component of the second door system 61 is designed as a reader 31 as a further door component type 48. In particular, the reader 31 can communicate wirelessly with a card or a mobile telephone in order to receive an access attribute. An access decision is made by the control device 30.

The door drives 35, 36 of the third door system 62 are designed to each be arranged on a door leaf of an interlock, each with a single-leaf door. The third door system 62 comprises two motor locks 33, 59 each for an active leaf. The motor locks each belong to the same door component type 40. The door system 62 also comprises a plurality of readers 29, 31, with one reader each being provided for arrangement on a door of the interlock.

The door components 33, 35, 51, 52, 53 of the first door system 60 are connected to a first bus system 32. Some door components 33, 34, 35, 36 of the second door system 61 are connected to the first bus system 32. Other door components 37, 38, 39 of the second door system 61 are only indirectly connected to the control device 30 via a door drive 35, 36. The reader 31 is connected to the control device 30 via a third bus system 55, e.g. an RS485 bus, or an RS232 connection.

The door components 30, 33, 35, 36, 56, 57, 58 of the third exemplary embodiment 62 are connected to the first bus system 32. The components 29, 30, 31 are connected via the third bus system 55.

The control device 30 comprises a transmitting and receiving unit for wireless near-field communication with a mobile terminal 50. The door arrangement according to the disclosure comprises the mobile terminal 50.

Since the first door system 60, the second door system 61 and the third door system 62 comprises different door components, the door systems 60, 61, 62 correspond to different door system types 70, 71, 72.

A door system 60, 61, 62 is characterized in that each door system 60, 61, 62 comprises a common electronic configuration. The configuration 82 is designed as at least one electronic file and can be stored on the control device 30. Exactly one configuration for each door system type 70, 71, 72 is preferably provided.

A door system 60, 61, 62 each comprises a common control device 30. The control device is used to connect to the computing unit 10.

Depending on the door system type 70, 71, 72, a door system 60, 61, 62 can be provided for arrangement on one or a plurality of doors. In a further exemplary embodiment, not represented, a door system is used, for example, for arrangement on two double-leaf doors arranged one behind the other or in a hotel corridor with e.g. four room doors.

It can be that a door arrangement 100 comprises a plurality of door systems 60, 61, 62. The door systems 60, 61, 62 can belong to the same or different door system types 70, 71, 72. The door systems 60, 61, 62 are preferably connected to one another and/or to the computing unit 10 via the second bus system 25.

The door systems 60, 61, 62 each comprise signal-transmitting door components, i.e. a signal transmitter.

In the door system 60, the signal transmitter is designed as a key switch 511 and as the smoke detector 53. The escape route controller 51 can report the signal of the key switch 511 to the control device 30. It is stored in the control device 30, in which case the door drive 35 is to be actuated so that the door is opened, closed or stopped by motor.

To this end, the control device 30 comprises firmware. A process with a plurality of operating steps can be controlled by means of the firmware. For example, an authorized user can gain access as the process by means of the key switch 511 as an authentication device. The escape route controller 51 reports the authentication to the control device 30. The escape route controller 51 also reports to the control device 30 the length of the unlocking time of the door lock 52, which the escape route controller 51 has actuated for unlocking. The control device 30 then actuates the door drive 35 for motorized door opening and informs the door drive 35 of the unlocking time or a hold-open time adapted to the unlocking time. The drive controller 351 at this point first actuates the motor lock 33 for unlocking and then the motor 352 for motorized opening of the door.

The control device 30 of the door system 60 can comprise rules as to when the door is to be opened or closed by motor in the case of a signal of the smoke detector 53.

In the door system 61, the signal transmitters are designed as the sensors 37, 38 and as the reader 31. The sensors 37, 38 are connected directly e.g. via an analog line to the door drive 35, 36, in particular the drive controllers 351, 361. The control device 30 does not evaluate the signals of the sensors 37, 38.

The control device 30 of the door system 61 evaluates the signals of the reader 31. As a process, it can be provided that first the reader 31 reports to the control device 30 the access attribute, which the reader 31 has received from a mobile terminal 50. The control device 30 decides whether the access attribute authorizes access. If this is the case, the control device 30 first actuates the door drive 35 of the active leaf and then the door drive 36 of the passive leaf in order to open the door by motor on both sides. At least one of the drive controllers 351, 361 of the door drives 35, 36 first actuates the motor locks 33, 34 so that the motor locks 33, 34 unlock the active leaf and the passive leaf. Thereafter, the drive controllers 351, 361 actuate the motors 352, 362 to open the door by motor.

The control device 30 can comprise a database. In the database are parameters, e.g. a hold-open time assigned to individual access attributes or individual access attribute groups for the motorized door opening. For example, an access attribute group “Senior” can be provided. A long hold-open time is assigned to this access attribute group. Together with the command to open the door by motor, the control device 30 transmits the hold-open time via first bus system 32. Alternatively, the control device 30 measures the duration of the hold-open time using a timer and, at the end of the hold-open time, commands the drive controller 351 to actuate motor 352 to close the door.

It is also stored in the database whether the door is to be opened with one or two leaves for individual access attributes or individual access attribute groups. An opening mode can thus be assigned to access attributes or access attribute groups in the database. For example, a double-leaf door opening can be assigned to the “Nurse” access attribute group and a single-leaf door opening to the “Doctor” access attribute group. If the control device 30 determines that a user from the access attribute group who is assigned a single-leaf door opening is looking for access, the control device 30 will actuate the door drive 35 to open the door, but not door drive 36.

It is also conceivable that the type of use of the access attribute or the element comprising the access attribute decides on a parameter or the opening mode. For example, a long presentation of the mobile terminal 50 comprising the access attribute at the reader 31 leads to a longer hold-open time than a short presentation of the terminal 50 at the reader 31. A long presentation can additionally or alternatively e.g. lead to a double-leaf opening, while a short presentation leads to a single-leaf opening.

In an alternative, the control device 30 does not comprise the database, but the assignment of the parameters or opening modes to access attributes or access attribute groups takes place in the computing unit 10, preferably in the third database 22. The control device 30 can query the computing unit 10 when making the access decision.

In a further alternative, the parameter or the opening mode is part of the access attribute. In this case, the parameter or the opening mode is transmitted wirelessly from the mobile terminal 50 to the reader 31 when the access authorization request is made. The reader 31 sends the parameter or the opening mode to the control device 30 via the third bus system 55.

In the door system 62, the signal transmitters are the sensors 56, 57 and the readers 29, 31. The sensors 56, 57 are evaluated by the control device 30. Depending on the result of the evaluation, the control device 30 actuates the drive controller 351, 361 so that the door is opened by motor.

The control device 30 of the door system 62 evaluates the signals of the readers 29, 31. For this purpose, the reader 29, 31 reports to the control device 30 the access attribute, which the reader 29, 31 has received from a mobile terminal 50. The control device 30 decides whether the access attribute authorizes access and actuates the drive controller 351, 361 so that the door is opened by motor. In this case, the control device 30 first actuates the motor locks 33, 59 in order to unlock the corresponding door.

The control device 30 of the door system 62 is aware of which sensor 56, 57 is assigned to which door or which door drive 35, 36. The control device 30 is also aware of which reader 29, 31 is assigned to which door or which door drive. For example, the sensor 56 and the reader 29 are assigned to the door drive 35. The sensor 57 and the reader 31 are assigned to the door drive 36. In the event of a positive evaluation of a signal of the sensor 56 or the reader 29, only the door drive 35 is actuated. The same applies to the door drive 36. The assignment is stored in control device 30.

The condition that the first door must be closed so that the second door can be opened and vice versa is also stored in control device 30. The control device 30 monitors compliance with the condition. Thus, upon access through the interlock, the control device 30 can first open the first door and only open the second door when the first door is closed.

Access attributes or access attribute groups for which the condition cannot be met are stored in the control device 30. For example, the condition is not met for the access attribute group “Firefighter”, but rather both doors are opened immediately. This means that the control device 30 first actuates the motor locks 33, 59 for unlocking and then the drive controllers 351, 361 for motorized opening of the doors.

It is stored in the control device 30 for which access attributes or which use of an access attribute the program switch 58 automatically changes the operating mode. For example, the reader 29, 31 may receive the access attribute of the caretaker. This automatically switches the operating mode from automatic mode to manual mode. It may be that the automatic switching of the operating mode also depends on the type of use of the access attribute or the element comprising the access attribute. Additionally or alternatively, the automatic switching of the operating mode can be dependent on a time range. For example, the operating mode is automatically switched from automatic mode to manual mode only in the evenings between 6 p.m. and 8 p.m. The switching of the operating mode to automatic mode only takes place between 6 p.m. and 9 p.m.

It is stored in the control device 30 for which door the operating mode set by the program switch 58 is intended. For example, the operating mode only applies to one of the two doors or to both. It can be stored in the control device 30 for which access attribute or which access attribute group a setting of the operating mode extends to which doors. For example, for the access attribute group “Caretaker”, the operating mode changes for both doors, while for other access attributes, the operating mode changes for only the first door.

In order to make the complex decisions or to coordinate the processes, the control device 30 comprises corresponding firmware. Changes in the processes can be carried out by means of a firmware update, e.g. by the computing unit 10. Alternatively, an instruction for the firmware and/or parameters can also be updated. The drive controller 351, 361 and/or the escape route controller 51 also comprises firmware in order to participate in the processes. In this case, the higher-level control is carried out by the control device 30. The update for the escape route controller 51 can only be carried out on site. This requires an action by the installer on the escape route system 51, 511, 512, 52.

The control processes are divided up such that control processes responsible for the special properties of a motor, e.g. a specific sliding door motor, are taken over by the drive controller 351, 361. Higher-level control processes, e.g. when which locking element 33, 34, 59 or which door drive 35, 36 is to be actuated, are preferably and/or predominantly taken over by the control device 30. As a result, the door drive 35, 36 can be exchanged without the rest of the door system 60, 61, 62 having to be extensively adapted. In particular, no modified cabling is necessary.

It can be provided that the control device 30 communicates in encrypted form via the first, the second and/or the third bus system 25, 32, 55.

Another way of discovering manipulations in the door system 60, 61, 62 is that the door system 60, 61, 62, in particular the control device 30, has knowledge of door components installed in the door system and is designed to determine changes to the installed door components and/or the function of the door components.

If a change is determined, the door system 60, 61, 62, in particular the control device 30, generates an alarm.

In order that the control device 30 has knowledge of the door components 29, 31, 33, 34, 35, 36, 51, 52, 53, 56, 57, 58, 59 installed in the door system and can carry out an assignment of door components 29, 31, 33, 34, 35, 36, 51, 52, 53, 56, 57, 58, 59 in such manner that the correct door components 29, 31, 33, 34, 35, 36, 51, 52, 53, 56, 57, 58, 59 are actuated and/or notified in the correct order in the process, the following commissioning process is provided.

The electronic configuration 82 comprises a list of components in each case, in which are listed the provided door components of the door system 60, 61, 62 or the provided door components 33, 34, 35, 36, 51, 52, 53, 56, 57, 58 of the door system 60, 61, 62, which are connected to the control device 30 in terms of information technology. If door components are present multiple times, the list of components comprises position information. In the exemplary embodiment of FIG. 2, the position information is “door drive for the active leaf”, “door drive for the passive leaf”. In the exemplary embodiment of FIG. 3, the position information reads “door drive for the first door”, “door drive for the second door”, “sensor for the first door”, “sensor for the second door”, “motor lock for the first door”, “ motor lock for the second door”, “reader for the first door” and “reader for the second door”.

Each door component connected to the first bus system 32 receives its own bus address from the control device 30. Each door component 33, 35, 36, 51, 52, 53 of the door system 60 connected to the first bus system 32 sends the control device 30 the door component type 40, 41, 44, 45, 46 of the respective door component 33, 35, 36, 51, 52, 53. If each door component type 40, 41, 44, 45, 46 is present only once in the door system 60, 61, 62, the control device 30 assigns the bus address to each door component type and thus to each door component. Thus, when the controller 30 has a message or command to send to a specific door component, the control device 30 knows the bus address. Alternatively, the control device 30 sends the bus addresses to the mobile terminal 50 so that the assignment to the mobile terminal 50 takes place. The assignment is then sent to the control device directly or indirectly via the computing unit 10.

If there are a plurality of door components of the same door component type or if particularly reliable commissioning is to take place, then all door components or at least the door components 35, 36 that are present multiple times and connected to the first bus system 32 are to be assigned to a position. In the door system 61, the door components that are present multiple times are the door drives 35, 36, of which a door drive 36 is in the position “on the passive leaf” and a door drive 35 is in the position “on the active leaf”. Therefore, identifiers of the door drives 35, 36, e.g. the bus address, or a marking assigned to the identifier, e.g. “door drive 1” or “door drive 2” is displayed to an installer during a commissioning process on the mobile terminal 50 after this information has been sent from the control device 30 to the mobile terminal 50. In addition, the positions of the door drives “on the passive leaf” and “on the active leaf” are displayed to the installer on the mobile terminal 50, in particular simultaneously or one after the other.

The installer can now select an identifier or marking, e.g. for the door drive 35. The selected control device 30 then receives the command from the mobile terminal 50 that the selected door drive 35 has to emit a visual and/or acoustic signal. The control device 30 informs the door drive 35 of the command. The door drive 35 then emits a visual and/or acoustic signal. To this end, the door drive 36 can set a sign using means that the door drive 35 also uses during operation. For example, the door drive 35 can jolt the door or move the door a little.

The installer now sees the position at which the selected door drive 35 is arranged, in this case on the active leaf. On the mobile terminal 50, the installer can enter the correct position. The mobile terminal 50 transmits the correct position “on the active leaf” and the identifier of the selected door drive 36 to the control device 30.

The control device 30 or the mobile terminal 50 assigns the bus address to each door component whose position has thus become known to the control device 30 or to the mobile terminal 50. In the case of assignment in the mobile terminal 50, the assignment is sent to the control device 30. Thus, when the controller 30 has a message or command to send to a specific door component, the control device 30 knows the bus address. For example, the control device 30 has to send a message to the door drive 35 of the active leaf, but not to the door drive 36 of the passive leaf.

The readers 29, 31 can also be assigned in an analogous manner by the installer by issuing a visual or acoustic sign, an identifier or a marking.

The electronic configuration 82 preferably comprises information about which door components connected to the first or third bus system 32, 55 exchange which messages. Thus, the electronic configuration 82 comprises transmitters and receivers of messages.

The electronic configuration 82 preferably contains preset parameters for the door system 60, 61, 62, e.g. an unlocking time of the door lock 52 or a hold-open time for the door drive 35, 36.

The electronic configuration 82 comprises executable firmware or firmware instructions for the control device 30 and other control units, e.g. the drive controllers 351, 361 or the escape route controller 51. This allows the processes to be carried out.

Exactly one predefined electronic configuration 82 is preferably provided for each door system type 70, 71, 72. The installer can load the configuration 82 from the first or the second database 20, 21 during the commissioning process.

1. A door system for one or a plurality of doors, the door system comprising:
at least one motorized door drive,
wherein the door drive comprises a motor and a drive controller for actuating the motor of the door drive,
wherein
the door system comprises a control device which is connected to the drive controller,
wherein the door system comprises at least one locking element, wherein a process is predefined by firmware, wherein the process comprises an operating step to be carried out by the motor and an operating step to be carried out by the locking element.

2. The door system according to claim 1, wherein the drive controller and the control device are connected to one another with a first bus system, wherein the control device is configured to be connected to a second bus system, wherein the control device is designed to receive an electronic configuration for controlling the door system via the second bus system.

4. The door system according to claim 1, wherein the drive controller is designed to accelerate and/or brake the motor such that a door is opened, stopped and/or closed.

5. The door system according to claim 1, wherein the control device comprises at least one processor and the drive controller comprises at least one processor, wherein the control device has the higher computing power than the drive controller, in particular wherein the control device comprises a hardware accelerator. processing unit.

6. The door system according to claim 1, wherein the control device is designed to evaluate, based on received signals, whether the door is to be opened, stopped or closed by the motor, wherein the control device causes the drive controller to actuate the motor based on the evaluation.

7. The door system according to claim 1, wherein the door system comprises at least one sensor, wherein a signal of the sensor is used to cause the door to open, stop and/or close by the door drive, wherein the sensor is connected to the first bus system and/or wherein the door system is designed to evaluate the signals of the sensor by way of the control device, wherein the control device causes the drive controller to actuate the motor based on the evaluation.

8. The door system according to claim 1, wherein at least one parameter for actuating the motor is stored in the control device and/or can be received by the control device, wherein the control device causes the drive controller to actuate the motor accordingly, wherein the parameters are used for setting at least one of the following features of the door system:
an opening speed of the door,
a closing speed of the door,
a hold-open time of the door,
a motor power of the motor,
an opening width or an opening angle of the door, and
an actuation of the motor as a function of a user action, in particular as a function of a door handle being actuated to open the door.

9. The door system according to claim 1, wherein at least one parameter for actuating the motor is stored individually for authorized users or for authorized user groups or individually for access attributes or for access attribute groups in the door system, in the control device and/or can be received by the door system, by the control device.

10. The door system according to claim 1, wherein the door system, comprises a memory, wherein firmware is stored in the memory, wherein the firmware is independent of the configuration of the motor of the door drive.

11. The door system according to claim 1, wherein it is predefined in the door system, in the firmware, under which environmental conditions and in what way the motor is to be actuated, wherein in the event of danger whether the door is to be opened or closed by the motor.

12. The door system according to claim 1, wherein the door system comprises a control device and a plurality of door drives, wherein the door drives each comprise a drive controller, wherein the control device is designed to coordinate the drive controllers for a process, wherein the door drives are designed to each be arranged on a door leaf of a double-leaf door and/or on door leaves of doors arranged one behind the other.

13. The door system according to claim 11, wherein the drive controllers are connected to the same first bus system and/or the process is stored in firmware.

14. The door system according to claim 1, wherein the locking element is connected to the first bus system.

15. The door system according to claim 1, wherein the door system comprises an authentication device, wherein the authentication device is designed to receive an access attribute for authentication, wherein the door system is designed, based on the access attribute and/or the type of use of the access attribute,
to switch an operating type of the door drive, from automatic mode, in which in the case of an approach of a person to the door detected by sensors, the door drive opens the door by motor, to manual mode, in which in the case of an approach of a person to the door detected by sensors, the door drive does not open the door by motor, or from manual mode to automatic mode,
to actuate a door drive to open a door leaf or a plurality of door drives to open a plurality of door leaves,
to adhere to or to override a timed process for actuating a motor of a second door drive after actuating a motor of a first door drive according to a condition stored in the door system.

16. The door system according to claim 1, wherein the door system comprises a motor lock, wherein the drive controller actuates the motor lock, wherein the motor lock is connected to the first bus system.

17. The door system according to claim 1, wherein it is stored in the firmware which door components of the door system, which are connected to the first bus system (32), are necessary for the process, wherein the door system, checks whether the door components are connected to the first bus system, wherein the door system refuses to carry out the process if the result of the test is negative.

18. The door system according to claim 1, wherein the drive controller and the control device are arranged in a housing, wherein the housing accommodates a motor of the door drive.

19. The door system according to claim 2, wherein the electronic configuration comprises the firmware or instructions for the firmware.

20. The door system according to claim 2, wherein the electronic configuration is predefined for a door system type and can be loaded from a first or second database during a commissioning process.

21. The door system according to claim 2, wherein the electronic configuration comprises a list of components in which are listed the intended door components of the door system, which are connected to the control device in terms of information technology.

22. The door system according to claim 2, wherein a bus address has been linked to a role of the door component in the door system during commissioning, wherein the link is stored in the control device.
